(19) United States
(12) Patent Application Publication
(10) Pub. No.: US 2022/0155805 A1
(43) Pub. Date: May 19, 2022

(54) METHOD FOR ADJUSTING FURNACE TEMPERATURE OF A REFLOW OVEN, AND ELECTRONIC DEVICE USING THE SAME

(71) Applicants: HONGFUJIN PRECISION ELECTRONICS (CHENGDU) CO., Ltd., Changdu (CN); HON HAI PRECISION INDUSTRY CO., LTD., New Taipei (TW)

(72) Inventors: ZI-QING XIA, Chengdu (CN); OU-YANG LI, Chengdu (CN); MIN CHEN, Chengdu (CN); YI-KUN WANG, Chengdu (CN); SU-RU CHEN, New Taipei (TW); YI-CHING CHEN, New Taipei (TW)

(21) Appl. No.: 17/522,081

(22) Filed: Nov. 9, 2021

(30) Foreign Application Priority Data
Nov. 16, 2020 (CN) 202011281654.8

(51) Int. Cl. G05D 23/19; G05B 13/02; F27D 19/00; B23K 3/047

(52) U.S. Cl. CPC G05D 23/1917; G05B 13/0265; G05D 23/1931; F27D 2019/0096; B23K 3/0478; F27D 2019/0003; F27D 19/00

(57) ABSTRACT

A method for adjusting furnace temperature of a reflow oven by AI, through obtaining product data of the reflow oven, obtaining initial characteristic data of a preceding work station and calculating mean values of temperatures of an upper furnace and a lower furnace, and taking the mean values as initial reflow characteristic data. Data as to first reflow characteristics of each reflow temperature zone and second reflow characteristics data of each zone are obtained, and data of the first and second reflow characteristics data are obtained. The electronic device further combines the characteristic data of the preceding work station with the combined reflow characteristics and combines results into a trained neural network model to output a temperature prediction, the oven temperature being adjusted according to the temperature prediction.

### CROSS-REFERENCE TO RELATED APPLICATIONS

This application claims priority to Chinese Patent Application No. 202011281654.8 filed on Nov. 16, 2020, the contents of which are incorporated by reference herein.

### FIELD

The subject matter herein generally relates to a field of industrial processes, and especially relates to a method for adjusting furnace temperature of a reflow oven, and an electronic device.

### BACKGROUND

In prior art, setting and adjustment of furnace temperature or temperatures of a reflow oven mainly depends on continuous trial by furnace personnel, and finally obtaining a better or optimal furnace temperature. The number of the trials is limited and effectiveness is closely related to the experience of the operators. Generally, once the setting is completed, the furnace temperature of the reflow furnace will not be adjusted except for periodic adjustment, which increases a risk of poor soldering function of the reflow furnace.

### BRIEF DESCRIPTION OF THE DRAWINGS

Implementations of the present disclosure will now be described, by way of embodiment, with reference to the attached figures.

FIG. 1 is a flowchart of one embodiment of a method for adjusting furnace temperature of a reflow oven.

FIG. 2 is a block diagram of one embodiment of a device for adjusting furnace temperature of a reflow oven.

FIG. 3 is a schematic diagram of one embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

A method for adjusting furnace temperature of a reflow oven is disclosed. The method is applied in one or more electronic devices. The electronic device can automatically perform numerical calculation and/or information processing according to a number of preset or stored instructions. The hardware of the electronic device includes, but is not limited to, a microprocessor, an Application Specific Integrated Circuit (ASIC), a Field Programmable Gate Array (FPGA), a Digital signal processor (DSP), or an embedded equipment, etc.

In one embodiment, the electronic device can be a desktop computer, a notebook computer, a tablet computer, a cloud server, or other computing devices. The device can carry out a human-computer interaction with user by a keyboard, a mouse, a remote controller, a touch pad or a voice control device.

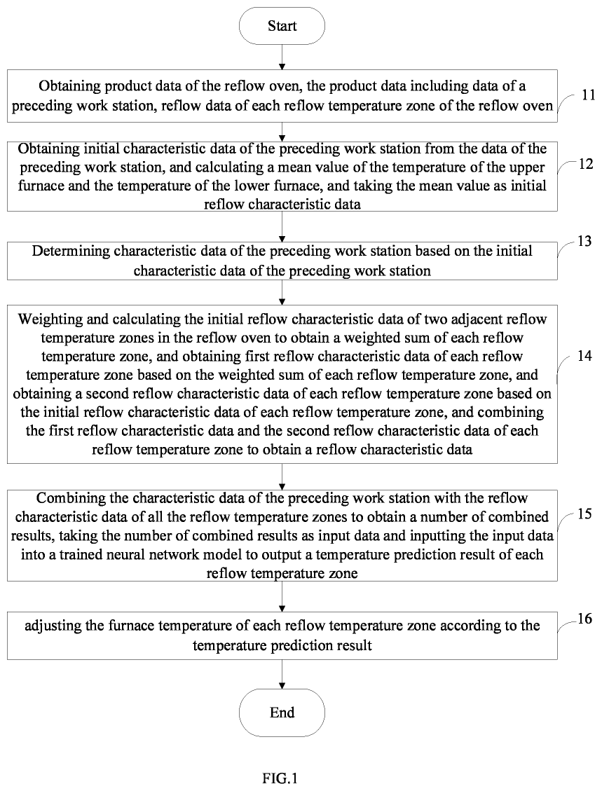

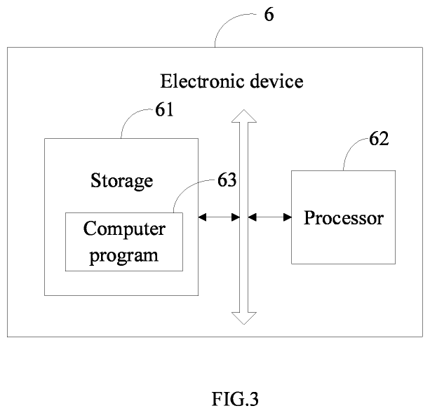

FIG. 1 illustrates the method for adjusting furnace temperature of a reflow oven. The method is applied in the electronic device 6 (referring to FIG. 3). The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 11.

At block 11, obtaining product data of the reflow oven, and the product data including data of a preceding work station, reflow data of each reflow temperature zone of the reflow oven, and the reflow data including a temperature of an upper furnace of the reflow oven, and a temperature of a lower furnace of the reflow oven.

In one embodiment, the data of the preceding work station includes an area of a solder paste point, an area percentage of the solder paste point, a volume percentage of the solder paste point, and a height percentage of the solder paste point.

At block 12, obtaining initial characteristic data of the preceding work station from the data of the preceding work station, and calculating a mean value of the temperature of the upper furnace and the temperature of the lower furnace, and taking the mean value as initial reflow characteristic data.

In one embodiment, obtaining initial characteristic data of the preceding work station from the data of a preceding work station includes:

obtaining the area of the solder paste point, the area percentage of the solder paste point, the volume percentage of the solder paste point and the height percentage of the solder paste point from the data of the preceding work station;

dividing the solder paste point area, and carrying out a normal conversion to data of the solder paste point area;

eliminating data that exceeds a preset probability distribution in relation to normal conversion result of the solder paste point area;

taking a first statistical value of the area of the solder paste point, a second statistical value of the volume percentage of the solder paste point, and a third statistical value of the height percentage of the solder paste point as the initial characteristic data.

For example, the electronic device divides the solder paste point area into four sections according to a range between 0 and 1, a range between 1 and 5, a range between 5 and 8, and fourthly a range greater than 8, and carries out the normal conversion to the divided solder paste point area data. A three-scale parameter range centered on a location parameter is taken as the preset probability distribution, and data that exceeds the preset probability distribution in a normal conversion result of the solder paste point area is eliminated. A median value of the area of the solder paste point, a median value of the volume percentage of the solder paste point, and a median value of the height percentage of the solder paste point are taken as the data relating to initial characteristics.

At block 13, determining characteristic data of the preceding work station based on the initial characteristic data of the preceding work station.

In one embodiment, determining characteristic data of the preceding work station based on the initial characteristic data of the preceding work station includes:

carrying out a polynomial conversion to the initial characteristic data of the preceding work station, and upgrading a dimension of the initial characteristic data of the preceding work station to a first preset dimension;

normalizing the initial characteristic data of the preceding work station after the dimension of the initial characteristic data is upgraded;

taking a product of a normalized converted initial characteristic data of the preceding work station and a first preset multiple as the characteristic data of the preceding work station.

In one embodiment, the first preset multiple can be 100. In one embodiment, the electronic device 6 carries out the polynomial conversion to the initial characteristic data of the preceding work station, and upgrades a dimension of the initial characteristic data of the preceding work station into 91 dimensions, normalizes the initial characteristic data of the preceding work station, and takes the product of the normalized converted initial characteristic data of the preceding work station and 100 as the characteristic data of the preceding work station.

At block 14, weighting and calculating the initial reflow characteristic data of two adjacent reflow temperature zones in the reflow oven to obtain a weighted sum of each reflow temperature zone, and obtaining first reflow characteristic data of each reflow temperature zone based on the weighted sum of each reflow temperature zone, and obtaining a second reflow characteristic data of each reflow temperature zone based on the initial reflow characteristic data of each reflow temperature zone, and combining the first reflow characteristic data and the second reflow characteristic data of each reflow temperature zone to obtain a reflow characteristic data.

In one embodiment, the electronic device 6 sets weight values for the initial characteristic data of the two adjacent reflow temperature zones of each reflow temperature zone, and calculates the initial reflow characteristic data of two adjacent reflow temperature zones to obtain the weighted sum of each reflow temperature zone according to the weight values. The electronic device 6 further multiplies the weighted sum of each reflow temperature zone by a second preset multiple to obtain the first reflow characteristic data of each reflow temperature zone, and multiplies the initial reflow characteristic data of each reflow temperature zone by the second preset multiple to obtain the second reflow characteristic data of each reflow temperature zone, and combines the first reflow characteristic data and the second reflow characteristic data of each reflow temperature zone to obtain the reflow characteristic data.

For example, the electronic device 6 sets weight values as 0.5 for the initial characteristic data of the two adjacent reflow temperature zones of each reflow temperature zone, and sets the second preset multiple as 0.1. The electronic device 6 calculates the initial reflow characteristic data of two adjacent reflow temperature zones to obtain the weighted sum of each reflow temperature zone according to the weight value of 0.5, multiplies the weighted sum of each reflow temperature zone by 0.1 to obtain the first reflow characteristic data [X₁, X₂, X₃, . . . , X_{N}], where N is a dimension of the first reflow characteristic data, and multiplies the initial reflow characteristic data of each reflow temperature zone by 0.1 to obtain the second reflow characteristic data [Y₁, Y₂, Y₃, . . . , Y_{M}], where M is a dimension of the second reflow characteristic data, and combines the first reflow characteristic data and the second reflow characteristic data of each reflow temperature zone to obtain the reflow characteristic data [X₁, X₂, X₃, . . . , X_{N}, Y₁, Y₂, Y₃, . . . , Y_{M}].

At block 15, combining the characteristic data of the preceding work station with the reflow characteristic data of all of the reflow temperature zones to obtain a number of combined results, taking the number of combined results as input data and inputting the input data into a trained neural network model to output a temperature prediction result of each reflow temperature zone.

In one embodiment, the temperature prediction result is a vector, a length of the vector is a number of all of the reflow temperature zones, and each value of the vector corresponds to a predicted furnace temperature of each reflow temperature zone.

In one embodiment, training a neural network model includes:

obtaining optical inspection data and maintenance record data of the reflow oven;

labeling the product data according to the optical detection data and the maintenance record data of the reflow oven;

processing the product data after labeling to obtain a training data, and using the training data to train the neural network model to obtain the trained neural network model.

In one embodiment, the optical detection data of the reflow oven includes maintenance records and absence of maintenance records, and the maintenance data includes maintenance records and absence of maintenance records.

In one embodiment, labeling the product data according to the optical detection data and the maintenance record data of the reflow oven includes:

labeling the product data as a failed sample when the optical inspection data or the maintenance record data of the reflow oven does have a maintenance record;

labeling the product data as a passing sample when the optical inspection data or the maintenance record data of the reflow oven does not contain maintenance record.

In one embodiment, processing the product data after labeling to obtain a training data includes:

for the product data marked as the passing samples, multiplying the reflow characteristic data by the first preset multiple to obtain passing sample labels, and taking the passing sample label as the labels of the product data when marked as passing samples;

for the product data marked as failed samples, taking average values of the temperatures of the upper furnace and the lower furnace of the reflow oven, which are marked as the passing samples and are closest in the product data are taken as the failed sample labels, and taking the failed sample labels as the labels of the product data marked as failed samples;

taking the product data and the label of the product data as the training data.

In one embodiment, the electronic device 6 labels the product data as the failed sample, when the optical inspection data or the maintenance record data of the reflow oven has the maintenance record, and the failed sample can be “0”. The electronic device 6 labels the product data as the passing sample when the optical inspection data or the maintenance record data of the reflow oven has no maintenance record, and the passing sample can be “1’.

In one embodiment, the first preset multiple can be 100. For the product data marked as the passing samples, the electronic device 6 multiplies the reflow characteristic data by 100 to obtain the passing sample labels, and takes the passing sample labels as labels of the product data marked as passing samples.

Ab block 16, adjusting the furnace temperature of each reflow temperature zone according to the temperature prediction result.

In one embodiment, the method further includes:

obtaining first furnace temperature data, equipment operation parameters, first key indicators, second furnace temperature data, first production data of products, first equipment life data, and second production data of products;

processing the first furnace temperature data;

inputting a processed first furnace temperature data and the equipment operation parameters into a first regression model, fitting the first key indicators by the first regression model to obtaining a key indicator prediction model;

processing the second furnace temperature data, inputting a processed second furnace temperature data and the equipment operation parameters into the key indicator prediction model, and predicting second key indicators by the key indicator prediction model;

training the second regression model with the first key indicators and the first production data of products as the input of the second regression model, and training the first equipment life data as the output of the second regression model to obtain the life prediction model;

inputting the second key indicators and the second production data of products into the life prediction model, and predicting the service life of equipment employed in the reflow temperature zone by the life prediction model.

In one embodiment, processing the first furnace temperature data includes: carrying out a polynomial conversion to the first furnace temperature data, and upgrading the dimension of the first furnace temperature data to a preset dimension.

In one embodiment, processing the second furnace temperature data includes: carrying out the polynomial conversion to the second furnace temperature data, and upgrading the dimension of the second furnace temperature data to the preset dimension.

In one embodiment, the first key indicators include, but are not limited to, a rising slope, a falling slope, a preheating time, a melting time, a constant temperature time, and a peak temperature of a furnace temperature curve.

In one embodiment, the first regression model can be an enhanced adaptive regression model.

In one embodiment, inputting processed first furnace temperature data and equipment operation parameters into a first regression model, and fitting the first key indicators by the first regression model to obtain a key indicator prediction model includes:

assigning random weights to the first furnace temperature data and the equipment operation parameters;

adjusting the weights a preset number of times to obtain the key indicator prediction model.

In one embodiment, adjusting the weights includes:

training the enhanced adaptive regression model using the first furnace temperature data and the equipment operation parameters with the weights;

calculating a maximum error between a result predicted by each adaptive regression model and the first key indicators;

calculating relative errors between the result predicted by each adaptive regression model and each first key indicator;

calculating a regression error rate according to the weights and the relative errors;

calculating coefficients of the enhanced adaptive regression model;

updating a weight distribution of a processed first furnace temperature data and the equipment operation parameters.

In one embodiment, the first production data of products includes fan speed, ice water temperature, and nitrogen and oxygen concentrations.

In one embodiment, the second regression model can be a regression model based on a neural network.

The present disclosure uses a large amount of data to train the neural network model, combined with the data changes of the reflow station and the maintenance records of the post reflow station, the furnace temperature of each reflow furnace can be adjusted in real time, so as to improve yield.

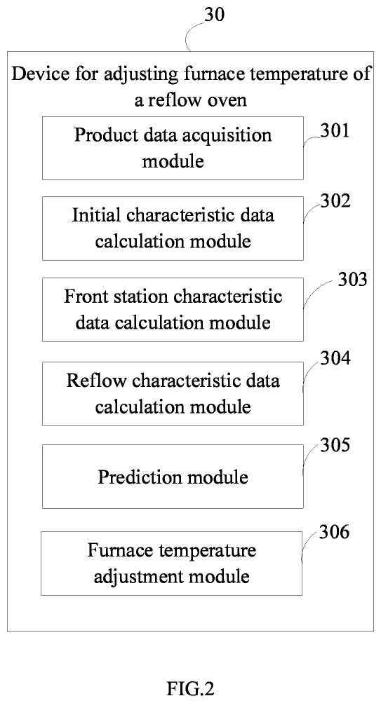

FIG. 2 illustrates a device 30 for adjusting furnace temperature of a reflow oven. The device 30 is applied in the electronic device 6. In one embodiment, according to the functions it performs, the device 30 can be divided into a plurality of functional modules. The functional modules perform the blocks 11-16 in the embodiment of FIG. 1 to perform the functions of adjusting furnace temperature of the reflow oven.

In one embodiment, the device 30 includes, but is not limited to, a product data acquisition module 301, an initial characteristic data calculation module 302, a front station characteristic data calculation module 303, a reflow characteristic data calculation module 304, a prediction module 305, and a furnace temperature adjustment module 306. The modules 301-306 of the device 30 can be collections of software instructions. In one embodiment, the program code of each program segment in the software instructions can be stored and executed by at least one processor to perform the required functions.

The product data acquisition module 301 obtains product data of the reflow oven, and the product data includes data of a preceding work station, reflow data of each reflow temperature zone of the reflow oven, and the reflow data including a temperature of an upper furnace of the reflow oven, and a temperature of a lower furnace of the reflow oven.

In one embodiment, the data of the preceding work station includes an area of a solder paste point, an area percentage of the solder paste point, a volume percentage of the solder paste point, and a height percentage of the solder paste point.

The initial characteristic data calculation module 302 obtains initial characteristic data of the preceding work station from the data of the preceding work station, calculates a mean value of the temperature of the upper furnace and the temperature of the lower furnace, and takes the mean values as initial reflow characteristic data.

In one embodiment, the initial characteristic data calculation module 302 obtaining the initial characteristic data of the preceding work station from the data of a preceding work station includes:

obtaining the area of the solder paste point, the area percentage of the solder paste point, the volume percentage of the solder paste point, and the height percentage of the solder paste point from the data of the preceding work station;

dividing the solder paste point area, and carrying out a normal conversion to the data of the solder paste point area;

eliminating data that a normal conversion result of the solder paste point area exceeds a preset probability distribution;

taking a first statistical value of the area of the solder paste point, a second statistical value of the volume percentage of the solder paste point, and a third statistical value of the height percentage of the solder paste point as the initial characteristic data.

The front station characteristic data calculation module 303 determines characteristic data of the preceding work station based on the initial characteristic data of the preceding work station.

In one embodiment, the front station characteristic data calculation module 303 determining characteristic data of the preceding work station based on the initial characteristic data of the preceding work station includes:

carrying out a polynomial conversion to the initial characteristic data of the preceding work station, and upgrading a dimension of the initial characteristic data of the preceding work station to a first preset dimension;

normalizing the initial characteristic data of the preceding work station after the dimension of the initial characteristic data is upgraded;

taking a product of a normalized converted initial characteristic data of the preceding work station and a first preset multiple as the characteristic data of the preceding work station.

The reflow characteristic data calculation module 304 applies weightings and calculates the initial reflow characteristic data of two adjacent reflow temperature zones to obtain a weighted sum of each reflow temperature zone, and obtains first reflow characteristic data of each reflow temperature zone based on the weighted sum of each reflow temperature zone, and obtains a second reflow characteristic data of each reflow temperature zone based on the initial reflow characteristic data of each reflow temperature zone, and combines the first reflow characteristic data and the second reflow characteristic data of each reflow temperature zone to obtain a reflow characteristic data.

In one embodiment, the reflow characteristic data calculation module 304 sets weighting values for the initial characteristic data of the two adjacent reflow temperature zones of each reflow temperature zone, and calculates the initial reflow characteristic data of two adjacent reflow temperature zones to obtain the weighted sum of each reflow temperature zone according to the weight values. The reflow characteristic data calculation module 304 further multiplies the weighted sum of each reflow temperature zone by a second preset multiple to obtain the first reflow characteristic data of each reflow temperature zone, and multiplies the initial reflow characteristic data of each reflow temperature zone by the second preset multiple to obtain the second reflow characteristic data of each reflow temperature zone, and combines the first reflow characteristic data and the second reflow characteristic data of each reflow temperature zone to obtain the reflow characteristic data.

The prediction module 305 combines the characteristic data of the preceding work station with the reflow characteristic data of all of the reflow temperature zones to obtain a number of combined results, takes the number of combined results as input data and inputs such data into a trained neural network model to output a temperature prediction result of each reflow temperature zone.

In one embodiment, the temperature prediction result is a vector, a length of the vector is a number of all of the reflow temperature zones, and each value of the vector corresponds to a predicted furnace temperature of each reflow temperature zone.

In one embodiment, the prediction module 305 training a neural network model includes:

obtaining optical inspection data and maintenance record data of the reflow oven;

labeling the product data according to the optical detection data and the maintenance record data of the reflow oven;

processing the product data after labeling to obtain a training data, and using the training data to train the neural network model to obtain the trained neural network model.

In one embodiment, the optical detection data of the reflow oven includes maintenance records and absence of maintenance records, and the maintenance data includes maintenance records and absence of maintenance records.

In one embodiment, the prediction module 305 labels the product data according to the optical detection data and the maintenance record data of the reflow oven includes:

labeling the product data as a failed sample when the optical inspection data or the maintenance record data of the reflow oven has a maintenance record;

labeling the product data as a passing sample when the optical inspection data or the maintenance record data of the reflow oven contains no maintenance record.

In one embodiment, the prediction module 305 processing the product data after labeling to obtain a training data includes:

for the product data marked as the passing samples, multiplying the reflow characteristic data by the first preset multiple to obtain passing sample labels, and taking the passing sample label as the labels of the product data marked as passing samples;

for the product data marked as failed samples, taking average values of the temperatures of the upper furnace and the lower furnace of the reflow oven, which are marked as the passing samples and are closest in the product data are taken as the failed sample labels, and taking the failed sample labels as the labels of the product data marked as failed samples;

taking the product data and the label of the product data as the training data.

The furnace temperature adjustment module 306 adjusts the furnace temperature of each reflow temperature zone according to the temperature prediction result.

In one embodiment, the device 30 further includes a life prediction module (not shown).

In one embodiment, the life prediction module further includes:

obtaining first furnace temperature data, equipment operation parameters, first key indicators, second furnace temperature data, first production data of products, first equipment life data, and second production data of products;

processing the first furnace temperature data;

inputting the processed first furnace temperature data and the equipment operation parameters into a first regression model, fitting the first key indicators by the first regression model to obtain a key indicator prediction model;

processing the second furnace temperature data, inputting a processed second furnace temperature data and the equipment operation parameters into the key indicator prediction model, and predicting second key indicators by the key indicator prediction model;

training the second regression model with the first key indicators and the first production data of products as the input of the second regression model, and training the first equipment life data as the output of the second regression model to obtain the life prediction model;

inputting the second key indicators and the second production data of products into the life prediction model, and predicting the service life of equipment in the reflow temperature zone by the life prediction model.

In one embodiment, the life prediction module processing the first furnace temperature data includes carrying out a polynomial conversion to the first furnace temperature data, and upgrading the dimension of the first furnace temperature data to a preset dimension.

In one embodiment, life prediction module processing the second furnace temperature data includes carrying out the polynomial conversion to the second furnace temperature data, and upgrading the dimension of the second furnace temperature data to the preset dimension.

In one embodiment, the first key indicators include, but not limited to, a rising slope, a falling slope, a preheating time, a melting time, a constant temperature time, and a peak temperature of a furnace temperature curve.

In one embodiment, the first regression model can be an enhanced adaptive regression model.

In one embodiment, the life prediction module inputting a processed first furnace temperature data and the equipment operation parameters into a first regression model and fitting the first key indicators by the first regression model to obtain a key indicator prediction model includes:

assigning random weights to the first furnace temperature data and the equipment operation parameters;

adjusting the weights according to a preset number of times to obtain the key indicator prediction model.

In one embodiment, the life prediction module adjusting the weightings includes:

training the enhanced adaptive regression model using the first furnace temperature data and the equipment operation parameters with the weights;

calculating a maximum error between a result predicted by each adaptive regression model and the first key indicators;

calculating relative errors between the result predicted by each adaptive regression model and each first key indicator;

calculating a regression error rate according to the weights and the relative errors;

calculating coefficients of the enhanced adaptive regression model;

updating a weight distribution of a processed first furnace temperature data and the equipment operation parameters.

In one embodiment, the first production data of products includes fan speed, ice water temperature, and nitrogen and oxygen concentration.

In one embodiment, the second regression model can be a regression model based on a neural network.

FIG. 3 illustrates the electronic device 6. The electronic device 6 includes a storage 61, a processor 62, and a computer program 63 stored in the storage 61 and executed by the processor 62. When the processor 62 executes the computer program 63, the blocks in the embodiment of the method for adjusting furnace temperature of a reflow oven are implemented, for example, blocks 11 to 16 as shown in FIG. 1. Alternatively, when the processor 62 executes the computer program 63, the functions of the modules in the embodiment of the device 30 for adjusting furnace temperature of a reflow oven are implemented, for example, modules 301-306 shown in FIG. 2.

In one embodiment, the computer program 63 can be partitioned into one or more modules/units that are stored in the storage 61 and executed by the processor 62. The one or more modules/units may be a series of computer program instruction segments capable of performing a particular function, and the instruction segments describe the execution of the computer program 63 in the electronic device 6. For example, the computer program 63 can be divided into product data acquisition module 301, initial characteristic data calculation module 302, front station characteristic data calculation module 303, reflow characteristic data calculation module 304, prediction module 305, and furnace temperature adjustment module 306, as shown in FIG. 2.

In one embodiment, the electronic device 6 can be a computing device such as a desktop computer, a notebook, a handheld computer, and a cloud terminal device. FIG. 3 shows only one example of the electronic device 6. There are no limitations of the electronic device 6, and other examples may include more or less components than those illustrated, or some components may be combined, or have a different arrangement. The components of the electronic device 6 may also include input devices, output devices, communication units, network access devices, buses, and the like.

The processor 62 can be a central processing unit (CPU), and also include other general-purpose processors, a digital signal processor (DSP), and application specific integrated circuit (ASIC), Field-Programmable Gate Array (FPGA) or other programmable logic device, discrete gate or transistor logic device, discrete hardware components, etc. The processor 62 may be a microprocessor or the processor may be any conventional processor or the like. The processor 62 is the control center of the electronic device 6, and connects the electronic device 6 by using various interfaces and lines. The storage 61 can be used to store the computer program 63, modules or units, and the processor 62 can realize various functions of the electronic device 6 by running or executing the computer program, modules, or units stored in the storage 61 and calling up the data stored in the storage 61.

In one embodiment, the storage 61 mainly includes a program storage area and a data storage area, wherein the program storage area may store an operating system, an application program (such as a sound playback function, an image playing function, etc.) required for at least one function, etc. The data storage area can store data (such as audio data, telephone book, etc.) created according to the use of electronic device 6. In addition, the storage 61 may also include a non-volatile memory, such as a hard disk, an internal memory, a plug-in hard disk, a smart media card (SMC), a secure digital (SD) card, a flash card, at least one disk storage device, a flash memory device, or other volatile solid state storage device.

In one embodiment, the modules/units integrated in the electronic device 6 can be stored in a computer readable storage medium if such modules/units are implemented in the form of a product. Thus, the present disclosure may be implemented and realized in any part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method for adjusting furnace temperature of a reflow oven comprising:
obtaining product data of the reflow oven, and the product data comprising data of a preceding work station and reflow data of each reflow temperature zone of the reflow oven, wherein the reflow data comprising a temperature of an upper furnace of the reflow oven and a temperature of a lower furnace of the reflow oven;
obtaining initial characteristic data of the preceding work station from the data of the preceding work station;
calculating a mean value of the temperature of the upper furnace and the temperature of the lower furnace and taking the mean value as initial reflow characteristic data;
determining characteristic data of the preceding work station based on the initial characteristic data of the preceding work station;
calculating the initial reflow characteristic data of two adjacent reflow temperature zones in the reflow oven and obtaining a weighted sum of each reflow temperature zone, and obtaining first reflow characteristic data of each reflow temperature zone based on the weighted sum of each reflow temperature zone;
obtaining a second reflow characteristic data of each reflow temperature zone based on the initial reflow characteristic data of each reflow temperature zone, and combining the first reflow characteristic data and the second reflow characteristic data of each reflow temperature zone and obtaining a reflow characteristic data;
combining the characteristic data of the preceding work station with the reflow characteristic data of all reflow temperature zones and obtaining a plurality of combined results, taking the plurality of combined results as input data and inputting the input data into a trained neural network model, and outputting a temperature prediction result of each reflow temperature zone by the trained neural network model; and
adjusting a furnace temperature of each reflow temperature zone according to the temperature prediction result.

2. The method as recited in claim 1, further comprising:
obtaining first furnace temperature data, equipment operation parameters, first key indicators, second furnace temperature data, first production data of products, first equipment life data, and second production data of products;
processing the first furnace temperature data;
inputting a processed first furnace temperature data and the equipment operation parameters into a first regression model, fitting the first key indicators by the first regression model and obtaining a key indicator prediction model;
processing the second furnace temperature data, inputting a processed second furnace temperature data and the equipment operation parameters into the key indicator prediction model, and predicting second key indicators by the key indicator prediction model;
training a second regression model with the first key indicators and the first production data of products as the input of the second regression model, and training the first equipment life data as the output of the second regression model, and obtaining the life prediction model; and
inputting the second key indicators and the second production data of products into the life prediction model and predicting the service life of equipment in the reflow temperature zone by the life prediction model.

3. The method as recited in claim 1, further comprising:
obtaining optical inspection data and maintenance record data of the reflow oven;
labeling the product data according to the optical detection data and the maintenance record data of the reflow oven; and
processing the product data after labeling, and obtaining a training data, and using the training data to train the neural network model and obtain the trained neural network model.

4. The method as recited in claim 1, further comprising:
obtaining an area of a solder paste point, an area percentage of the solder paste point, a volume percentage of the solder paste point, and a height percentage of the solder paste point from the data of the preceding work station;
dividing the solder paste point area and carrying out a normal conversion to data of the solder paste point area;
eliminating the data of the solder paste point area that exceeds a preset probability distribution; and
taking a first statistical value of the area of the solder paste point, a second statistical value of the volume percentage of the solder paste point, and a third statistical value of the height percentage of the solder paste point as the initial characteristic data.

5. The method as recited in claim 1, further comprising:
carrying out a polynomial conversion to the initial characteristic data of the preceding work station and upgrading a dimension of the initial characteristic data of the preceding work station to a first preset dimension;
normalizing the initial characteristic data of the preceding work station after the dimension of the initial characteristic data is upgraded; and
taking a product of a normalized converted initial characteristic data of the preceding work station and a first preset multiple as the characteristic data of the preceding work station.

6. The method as recited in claim 1, further comprising:
setting weight values for the initial characteristic data of two adjacent reflow temperature zones of each reflow temperature zone, and calculating the initial reflow characteristic data of the two adjacent reflow temperature zones, and obtaining the weighted sum of each reflow temperature zone according to the weight values;
multiplying the weighted sum of each reflow temperature zone by a second preset multiple, and obtaining the first reflow characteristic data of each reflow temperature zone;
multiplying the initial reflow characteristic data of each reflow temperature zone by the second preset multiple, and obtaining the second reflow characteristic data of each reflow temperature zone; and
combining the first reflow characteristic data and the second reflow characteristic data of each reflow temperature zone to obtain the reflow characteristic data.

7. The method as recited in claim 1, wherein the temperature prediction result is a vector, a length of the vector is a number of all reflow temperature zones; and each value of the vector corresponds to a predicted furnace temperature of each reflow temperature zone.

8. An electronic device comprising:
a processor; and
a non-transitory storage medium coupled to the processor and configured to store a plurality of instructions, which cause the processor to:
obtain product data of the reflow oven, wherein the product data comprising data of a preceding work station and reflow data of each reflow temperature zone of the reflow oven, wherein the reflow data comprises a temperature of an upper furnace of the reflow oven, and a temperature of a lower furnace of the reflow oven;
obtain initial characteristic data of the preceding work station from the data of the preceding work station;
calculate a mean value of the temperature of the upper furnace and the temperature of the lower furnace, and take the mean value as initial reflow characteristic data;
determine characteristic data of the preceding work station based on the initial characteristic data of the preceding work station;
calculate the initial reflow characteristic data of two adjacent reflow temperature zones in the reflow oven and obtain a weighted sum of each reflow temperature zone, and obtain first reflow characteristic data of each reflow temperature zone based on the weighted sum of each reflow temperature zone;
obtain a second reflow characteristic data of each reflow temperature zone based on the initial reflow characteristic data of each reflow temperature zone, and combine the first reflow characteristic data and the second reflow characteristic data of each reflow temperature zone, and obtain a reflow characteristic data;
combine the characteristic data of the preceding work station with the reflow characteristic data of all reflow temperature zones, and obtain a plurality of combined results, take the plurality of combined results as input data and inputting the input data into a trained neural network model, and output a temperature prediction result of each reflow temperature zone by the trained neural network model; and
adjust a furnace temperature of each reflow temperature zone according to the temperature prediction result.

9. The electronic device as recited in claim 8, wherein the plurality of instructions are further configured to cause the processor to:
obtain first furnace temperature data, equipment operation parameters, first key indicators, second furnace temperature data, first production data of products, first equipment life data and second production data of products;
process the first furnace temperature data;
input a processed first furnace temperature data and the equipment operation parameters into a first regression model, fit the first key indicators by the first regression model and obtain a key indicator prediction model;
process the second furnace temperature data, input a processed second furnace temperature data and the equipment operation parameters into the key indicator prediction model, and predict second key indicators by the key indicator prediction model;
train a second regression model with the first key indicators and the first production data of products as the input of the second regression model, and train the first equipment life data as the output of the second regression model, and obtain the life prediction model;
input the second key indicators and the second production data of products into the life prediction model and predict the service life of equipment in the reflow temperature zone by the life prediction model.

10. The electronic device as recited in claim 8, wherein the plurality of instructions are further configured to cause the processor to:
obtain optical inspection data and maintenance record data of the reflow oven;
label the product data according to the optical detection data and the maintenance record data of the reflow oven; and
process the product data after labeling, and obtain a training data, and use the training data to train the neural network model and obtain the trained neural network model.

11. The electronic device as recited in claim 8, wherein the plurality of instructions are further configured to cause the processor to:
obtain an area of a solder paste point, an area percentage of the solder paste point, a volume percentage of the solder paste point and a height percentage of the solder paste point from the data of the preceding work station;
divide the solder paste point area, and carry out a normal conversion to data of the solder paste point area;
eliminate the data of the solder paste point area that exceeds a preset probability distribution; and
take a first statistical value of the area of the solder paste point, a second statistical value of the volume percentage of the solder paste point, and a third statistical value of the height percentage of the solder paste point as the initial characteristic data.

12. The electronic device as recited in claim 8, wherein the plurality of instructions are further configured to cause the processor to:
carry out a polynomial conversion to the initial characteristic data of the preceding work station, and upgrade a dimension of the initial characteristic data of the preceding work station to a first preset dimension;
normalize the initial characteristic data of the preceding work station after the dimension of the initial characteristic data is upgraded; and
take a product of a normalized converted initial characteristic data of the preceding work station and a first preset multiple as the characteristic data of the preceding work station.

13. The electronic device as recited in claim 8, wherein the plurality of instructions are further configured to cause the processor to:
set weight values for the initial characteristic data of two adjacent reflow temperature zones of each reflow temperature zone, and calculate the initial reflow characteristic data of the two adjacent reflow temperature zones, and obtain the weighted sum of each reflow temperature zone according to the weight values;
multiply the weighted sum of each reflow temperature zone by a second preset multiple, and obtain the first reflow characteristic data of each reflow temperature zone;
multiply the initial reflow characteristic data of each reflow temperature zone by the second preset multiple, and obtain the second reflow characteristic data of each reflow temperature zone; and
combine the first reflow characteristic data and the second reflow characteristic data of each reflow temperature zone to obtain the reflow characteristic data.

14. The electronic device as recited in claim 8, wherein the temperature prediction result is a vector; and a length of the vector is a number of all reflow temperature zones, and each value of the vector corresponds to a predicted furnace temperature of each reflow temperature zone.

15. A non-transitory storage medium having stored thereon instructions that, when executed by at least one processor of an electronic device, causes the least one processor to execute instructions of a method for adjusting furnace temperature of a reflow oven, the method comprising:
obtaining product data of the reflow oven, and the product data comprising data of a preceding work station and reflow data of each reflow temperature zone of the reflow oven, wherein the reflow data comprising a temperature of an upper furnace of the reflow oven, and a temperature of a lower furnace of the reflow oven;
obtaining initial characteristic data of the preceding work station from the data of the preceding work station;
calculating a mean value of the temperature of the upper furnace and the temperature of the lower furnace, and taking the mean value as initial reflow characteristic data;
determining characteristic data of the preceding work station based on the initial characteristic data of the preceding work station;
calculating the initial reflow characteristic data of two adjacent reflow temperature zones in the reflow oven, and obtain a weighted sum of each reflow temperature zone, and obtaining first reflow characteristic data of each reflow temperature zone based on the weighted sum of each reflow temperature zone;
obtaining a second reflow characteristic data of each reflow temperature zone based on the initial reflow characteristic data of each reflow temperature zone, and combining the first reflow characteristic data and the second reflow characteristic data of each reflow temperature zone, and obtaining a reflow characteristic data;
combining the characteristic data of the preceding work station with the reflow characteristic data of all reflow temperature zones, and obtaining a plurality of combined results, taking the plurality of combined results as input data and inputting the input data into a trained neural network model, and outputting a temperature prediction result of each reflow temperature zone by the trained neural network model; and
adjusting a furnace temperature of each reflow temperature zone according to the temperature prediction result.

16. The non-transitory storage medium as recited in claim 15, the method further comprising:
obtaining first furnace temperature data, equipment operation parameters, first key indicators, second furnace temperature data, first production data of products, first equipment life data and second production data of products;
processing the first furnace temperature data;
inputting a processed first furnace temperature data and the equipment operation parameters into a first regression model, fitting the first key indicators by the first regression model, and obtaining a key indicator prediction model;
processing the second furnace temperature data, inputting a processed second furnace temperature data and the equipment operation parameters into the key indicator prediction model, and predicting second key indicators by the key indicator prediction model;
training a second regression model with the first key indicators and the first production data of products as the input of the second regression model, and training the first equipment life data as the output of the second regression model, and obtaining the life prediction model; and
inputting the second key indicators and the second production data of products into the life prediction model and predicting the service life of equipment in the reflow temperature zone by the life prediction model.

17. The non-transitory storage medium as recited in claim 15, the method further comprising:
obtaining optical inspection data and maintenance record data of the reflow oven;
labeling the product data according to the optical detection data and the maintenance record data of the reflow oven; and
processing the product data after labeling, and obtaining a training data, and using the training data to train the neural network model to obtain the trained neural network model.

18. The non-transitory storage medium as recited in claim 15, the method further comprising:
obtaining an area of a solder paste point, an area percentage of the solder paste point, a volume percentage of the solder paste point and a height percentage of the solder paste point from the data of the preceding work station;
dividing the solder paste point area, and carrying out a normal conversion to data of the solder paste point area;
eliminating the data of the solder paste point area that exceeds a preset probability distribution; and
taking a first statistical value of the area of the solder paste point, a second statistical value of the volume percentage of the solder paste point, and a third statistical value of the height percentage of the solder paste point as the initial characteristic data.

19. The non-transitory storage medium as recited in claim 15, the method further comprising:
carrying out a polynomial conversion to the initial characteristic data of the preceding work station, and upgrading a dimension of the initial characteristic data of the preceding work station to a first preset dimension;
normalizing the initial characteristic data of the preceding work station after the dimension of the initial characteristic data is upgraded; and
taking a product of a normalized converted initial characteristic data of the preceding work station and a first preset multiple as the characteristic data of the preceding work station.

20. The non-transitory storage medium as recited in claim 15, the method further comprising:
setting weight values for the initial characteristic data of two adjacent reflow temperature zones of each reflow temperature zone, and calculating the initial reflow characteristic data of the two adjacent reflow temperature zones, and obtaining the weighted sum of each reflow temperature zone according to the weight values;
multiplying the weighted sum of each reflow temperature zone by a second preset multiple, and obtaining the first reflow characteristic data of each reflow temperature zone;
multiplying the initial reflow characteristic data of each reflow temperature zone by the second preset multiple, and obtaining the second reflow characteristic data of each reflow temperature zone; and
combining the first reflow characteristic data and the second reflow characteristic data of each reflow temperature zone to obtain the reflow characteristic data.
